(19) United States
(12) Patent Application Publication
(10) Pub. No.: US 2015/0256213 A1
(43) Pub. Date: Sep. 10, 2015

(54) Radio-Frequency Transceiver System

(71) Applicant: Wistron NeWeb Corporation, Hsinchu (TW)

(72) Inventors: Cheng-Geng Jan, Hsinchu (TW); An-Shyi Liu, Hsinchu (TW); Chun-Hsiung Chuang, Hsinchu (TW); Horen Chen, Hsinchu (TW)

(21) Appl. No.: 14/583,760

(22) Filed: Dec. 28, 2014

(30) Foreign Application Priority Data
Mar. 6, 2014 (TW) 103107735

(51) Int. Cl. H04B 1/401; H04B 1/44

(52) U.S. Cl. CPC H04B 1/401; H04B 1/44; H04W 84/12

(57) ABSTRACT

A radio-frequency transceiver system adapted to a wireless local area network includes an antenna set, including a plurality of antenna units disposed toward a plurality of directions, a radio-frequency signal processing module for processing radio-frequency signals, and a switching module electrically coupled between the antenna set and the radio-frequency signal processing module for switching between different connection states of the radio-frequency signal processing module and the antenna units of the antenna set such that the radio-frequency transceiver system switches between an omnidirectional mode and a directional mode. In the omnidirectional mode, the antenna units are electrically connected to the radio-frequency signal processing module to transmit or receive radio-frequency signals omni-directionally. In the directional mode, one of the antenna units is electrically connected to the radio-frequency signal processing module to transmit or receive radio-frequency signals along a first direction of the plurality of directions.

### BACKGROUND OF THE INVENTION

1. Field of the Invention

The present invention relates to a radio-frequency transceiver system, and more particularly, to a radio-frequency transceiver system adapted to a wireless local area network and able to switch between an omnidirectional mode and a directional mode.

2. Description of the Prior Art

Electronic products with wireless communication functionalities, e.g. notebook computers, personal digital assistants, etc., utilize antennas to emit and receive radio waves, to transmit or exchange radio signals, so as to access a wireless communication network. With the advance of wireless communication technology, a wireless local area network standard IEEE 802.11n/ac supports multiple-input multiple-output (MIMO) communication technology, i.e. an electronic product capable of concurrently receiving/transmitting wireless signals via multiple (or multiple sets of) antennas, to vastly increase system throughput and transmission distance without increasing system bandwidth or total transmission power expenditure, thereby effectively enhancing spectral efficiency and transmission rate for the wireless communication system, as well as improving communication quality.

In a MIMO wireless local area network, an electronic product including an antenna with directivity can adjust antenna characteristics in order to operate between an omnidirectional mode and a directional mode. Therefore, it is a common goal in the industry to efficiently switch an electronic product between an omnidirectional mode and a directional mode.

### SUMMARY OF THE INVENTION

Therefore, the present invention provides a radio-frequency transceiver system able to switch between an omnidirectional mode and a directional mode and accommodated for multiple-input multiple-output (MIMO) system.

An embodiment of the present invention discloses a radio-frequency transceiver system, adapted to a wireless local area network, the radio-frequency transceiver system comprising an antenna set, comprising a plurality of antenna units, wherein the plurality of antenna units are respectively disposed toward a plurality of directions; a radio-frequency signal processing module, configured to process radio-frequency signals; and a switching module, electrically coupled between the antenna set and the radio-frequency signal processing module to switch the radio-frequency signal processing module between the plurality of antenna units of the antenna set, and to switch the radio-frequency transceiver system between an omnidirectional mode and a directional mode; wherein electric currents are conducted between the radio-frequency signal processing module and the plurality of antenna units operated in the omnidirectional mode to transmit or receive radio-frequency signals omni-directionally, and electric currents are conducted between the radio-frequency signal processing module and one of the plurality of antenna units operated in the directional mode to transmit or receive radio-frequency signals along a first direction of the plurality of directions.

An embodiment of the present invention further discloses a radio-frequency transceiver system, adapted to a wireless local area network, the radio-frequency transceiver system comprising a plurality of antenna sets, wherein each of the plurality of antenna sets comprises a plurality of antenna units, and the plurality of antenna units are respectively disposed toward a plurality of directions; a radio-frequency signal processing module, configured to process radio-frequency signals; and a switching module, electrically coupled between the plurality of the antenna sets and the radio-frequency signal processing module to switch the radio-frequency signal processing module between the plurality of antenna units of the plurality of antenna sets, and to switch the radio-frequency transceiver system between an omnidirectional mode and a directional mode; wherein electric currents are conducted between the radio-frequency signal processing module and the plurality of antenna units of at least one antenna set of the plurality of antenna sets operated in the omnidirectional mode to transmit or receive radio-frequency signals omni-directionally, and electric currents are conducted between the radio-frequency signal processing module and one of the plurality of antenna units of at least one antenna set of the plurality of antenna sets operated in the directional mode to transmit or receive radio-frequency signals along a first direction of the plurality of directions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a radio-frequency transceiver system according to an embodiment of the present invention.

FIG. 2 is a schematic diagram illustrating a radio-frequency transceiver system according to an embodiment of the present invention.

FIG. 3A is a schematic diagram illustrating a radio-frequency transceiver system according to an embodiment of the present invention.

FIG. 3B is a top-view schematic diagram illustrating the radio-frequency transceiver system shown in FIG. 3A.

FIG. 3C is a schematic diagram illustrating a radio-frequency transceiver system according to an embodiment of the present invention.

FIG. 4A is a schematic diagram illustrating a radio-frequency transceiver system according to an embodiment of the present invention.

FIG. 4B is a schematic diagram illustrating a radio-frequency transceiver system according to an embodiment of the present invention.

FIG. 4C is a schematic diagram illustrating a radio-frequency transceiver system according to an embodiment of the present invention.

FIG. 5A is a schematic diagram illustrating a radio-frequency transceiver system according to an embodiment of the present invention.

FIG. 5B is a schematic diagram illustrating a radio-frequency transceiver system according to an embodiment of the present invention.

FIG. 5C is a schematic diagram illustrating a radio-frequency transceiver system according to an embodiment of the present invention.

FIG. 5D is a schematic diagram illustrating a radio-frequency transceiver system according to an embodiment of the present invention.

FIG. 6A is a schematic diagram illustrating a radio-frequency transceiver system according to an embodiment of the present invention.

FIG. 6B is a schematic diagram illustrating a radio-frequency transceiver system according to an embodiment of the present invention.

FIG. 6C is a schematic diagram illustrating a radio-frequency transceiver system according to an embodiment of the present invention.

FIG. 7A is a schematic diagram illustrating the tilted antenna structure strata of the radio-frequency transceiver system shown in FIG. 6A.

FIG. 7B is a schematic diagram illustrating an included angle θ between the antenna structure strata shown in FIG. 6A.

FIG. 7C is a schematic diagram illustrating misalignments of a portion of the antenna sets of the radio-frequency transceiver system shown in FIG. 6A.

FIG. 7D is a schematic diagram illustrating the antenna sets of the radio-frequency transceiver system shown in FIG. 6A.

### DETAILED DESCRIPTION

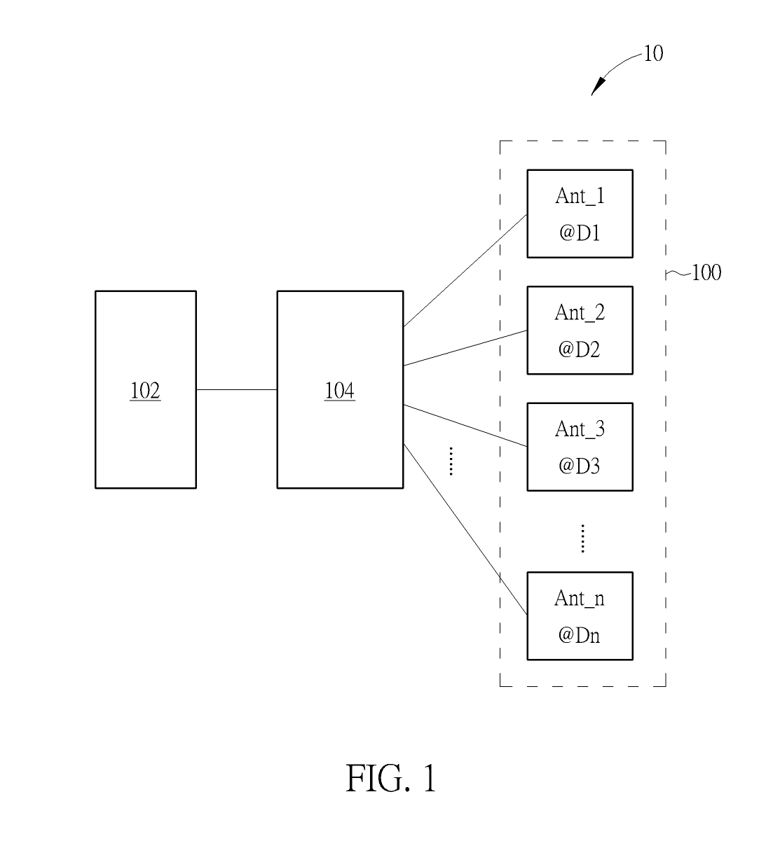

FIG. 1 is a schematic diagram illustrating a radio-frequency transceiver system 10 according to an embodiment of the present invention. As shown in FIG. 1, the radio-frequency transceiver system 10 maybe adapted to a wireless local area network (such as IEEE 802.11 wireless local area network), and comprises an antenna set 100, a radio-frequency signal processing module 102 and a switching module 104. The antenna set 100 comprises antenna units Ant_1-Ant_n. The antenna units Ant_1-Ant_n are disposed toward directions D1-Dn. The switching module 104 is coupled or electrically coupled between the antenna set 100 and the radio-frequency signal processing module 102 in order to switch the radio-frequency signal processing module 102 between the antenna units Ant_1-Ant_n, meaning that the radio-frequency signal processing module 102 can selectively process radio-frequency signals transmitted or received by the antenna units Ant_1-Ant_n. By switching the radio-frequency signal processing module 102 between the antenna units Ant_1-Ant_n with the switching module 104, the radio-frequency transceiver system 10 can switch between an omnidirectional mode and a directional mode to transmit or receive radio-frequency signals either omni-directionally or along a specific direction.

Specifically, the antenna units Ant_1-Ant_n are appropriately disposed, such that the directions D1-Dn substantially cover directions (space) around the radio-frequency transceiver system 10. When the radio-frequency transceiver system 10 is operated in the omnidirectional mode, the switching module 104 conducts electric currents between the antenna units Ant_1-Ant_n and the radio-frequency signal processing module 102. Therefore, the antenna units Ant_1-Ant_n of the radio-frequency signal processing module 102 transmit or receive radio-frequency signals together, causing the radio-frequency transceiver system 10 to transmit or receive radio-frequency signals omni-directionally. On the other hand, when the radio-frequency transceiver system 10 is operated in the directional mode, the switching module 104 only conducts electric currents between the radio-frequency signal processing module 102 and a portion of the antenna units Ant_1-Ant_n (i.e., one single antenna unit in the antenna units Ant_1-Ant_n or several antenna units in the antenna units Ant_1-Ant_n). Hence, radio-frequency signals are only transmitted between the radio-frequency signal processing module 102 and some of the antenna units Ant_1-Ant_n. In other words, the radio-frequency transceiver system 10 merely transmits or receives radio-frequency signals along certain direction(s). Accordingly, the radio-frequency transceiver system 10 can switch between the omnidirectional mode and the directional mode with the switching module 104. Take the radio-frequency transceiver system 10 implemented in a wireless access point of a wireless local area network as an example. When the wireless access point is operated in an idle mode or an initiate mode (e.g., upon startup or connection detecting), the switching module 104 can conduct electric currents between the antenna units Ant_1-Ant_n and the radio-frequency signal processing module 102, such that the radio-frequency transceiver system 10 is operated in the omnidirectional mode in order to detect or search stations. If the wireless access point has established a connection with a specific station, the wireless access point can modify connection between the antenna unit Ant_1-Ant_n and the radio-frequency signal processing module 102 with the switching module 104 according to location of the station. Therefore, electric currents are conducted between the radio-frequency signal processing module 102 and the antenna unit(s) with the best transmission efficiency to the station, and the other antenna units are blocked in order to provide directivity, to increase transmission efficiency, and to reduce power consumption.

Please note that in the radio-frequency transceiver system 10 the directions D1-Dn are denoted according to the configuration of the antenna units Ant_1-Ant_n. That is to say, the definition of the directions D1-Dn may depend on antenna types. For example, if the antenna units Ant_1-Ant_n are patch antennas, the directions D1-Dn can be respectively defined as a direction from a ground plane to the corresponding radiator. If the antenna units Ant_1-Ant_n are monopole antennas, the directions D1-Dn can be respectively defined as a direction either perpendicular to a radiator (i.e., a monopole) or from a ground plane to the end of the corresponding radiator furthest from the ground plane. If the antenna units Ant_1-Ant_n are dipole antennas, the directions D1-Dn can be respectively defined as a direction either perpendicular to a radiator or from a ground (or a ground terminal) to the center of the corresponding radiator. If the antenna units Ant_1-Ant_n are slot antennas, the directions D1-Dn can be respectively defined as a direction either along a slot or from a ground (or a ground terminal) to the corresponding radiator. The directions D1-Dn can be defined differently as well. For example, the directions D1-Dn can be respectively defined according to the direction of a main radiator, a direction of an extension of a radiator, a direction of an extension of a grounded element, a direction of a feed-in wire and so on.

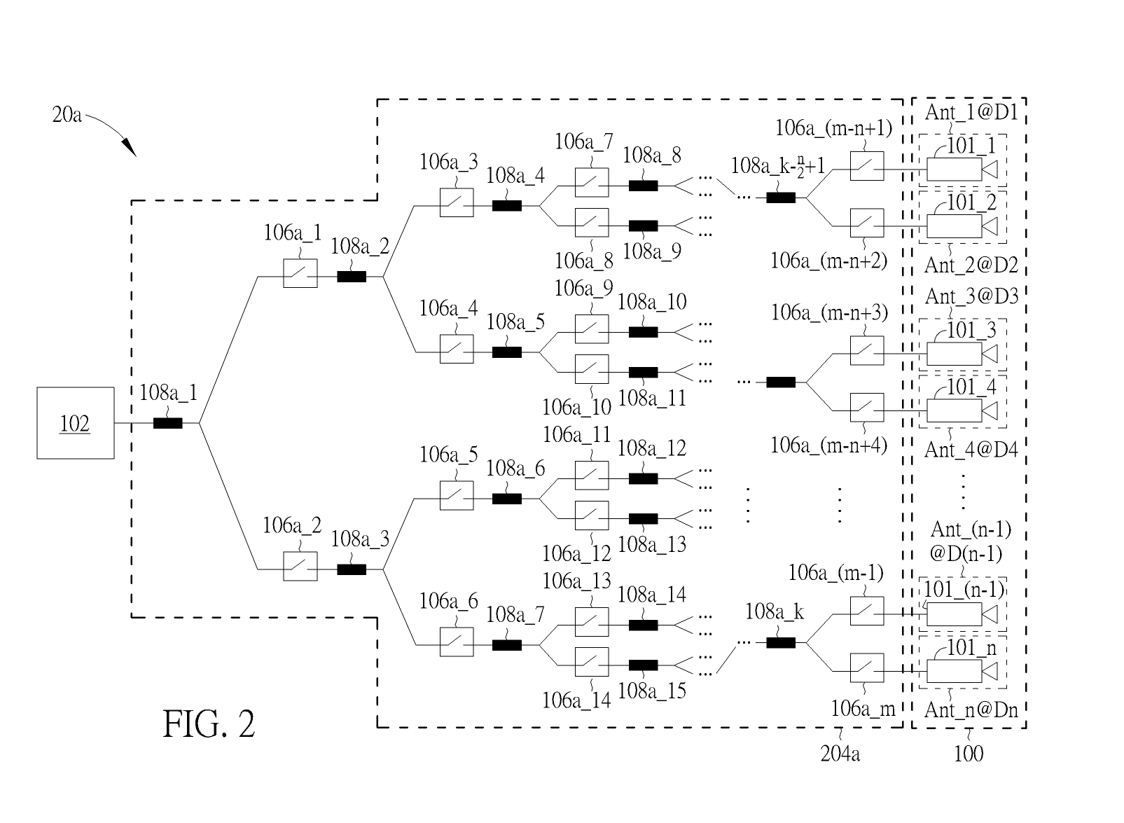

The radio-frequency transceiver system 10 is an exemplary embodiment of the invention, and those skilled in the art can make alternations and modifications accordingly. For example, the switching module 104 is utilized to switch the radio-frequency signal processing module between the antenna units, but may be implemented in any other approach or structure such as a multiplexer, a diode circuit, a micro-electromechanical systems (MEMS) switch circuit, a solid state switch circuit and a Single-pole N-throw (SPNT) switch circuit with power splitters. Moreover, the switching module 104 may be adjusted according to different system requirements or design considerations. FIG. 2 is a schematic diagram illustrating a radio-frequency transceiver system 20a according to an embodiment of the present invention. As shown in FIG. 2, a switching circuit 204a of the radio-frequency transceiver system 20a is a multistage switch circuit, and comprises switches 106a_1-106a_{—}m and transmission lines 108a_1-108a_{—}k respectively corresponding to the antenna units Ant_1-Ant_n. If the base of n is 2, meaning that the base 2 are multiplied together to get n, then m=2(n−1) and k=n−1. If n cannot be divided by 2 to give an integer, those switches and transmission lines that are not connected to an antenna unit can be removed; alternatively, the original antenna unit can be replaced by a radio frequency load or a resistor of 50 ohm. Consequently, the total number of the antenna units Ant_1-Ant_n and the radio frequency loads (or the resistors of 50 ohm) is 2 multiplied by itself many times. In the switching circuit 204a, the transmission lines 108a_1-108a_{—}k are respectively electrically connected two switches connected in parallel to form a multistage switch circuit. When the switches 106a_1-106a_{—}m are turned on to conduct electrical currents, the radio-frequency signals can be transmitted between the antenna unit Ant_1-Ant_n and radio-frequency signal processing module 102—in such a situation, the radio-frequency transceiver system 20a enters the omnidirectional mode to transmit or receive radio-frequency signals omni-directionally. On the other hand, if there is merely a portion of the switches switched on (for example, the switches 106a_1, 10a_3 and 106a_7-106a_ (m−n+1)) and hence the radio-frequency signals can be transmitted only between specific antenna units (e.g., the antenna unit Ant_1) and the radio-frequency signal processing module 102, the radio-frequency transceiver system 20a is operated in the directional mode, causing radio-frequency signals are transmitted or received along a specific direction. It is worth noting that whether the radio-frequency transceiver system 20a is in the omnidirectional mode or the directional mode, feed-in wires 101_1-101_{—}n and the transmission line 108a_1-108a_{—}k of the antenna units Ant_1-Ant_n meet impedance matching.

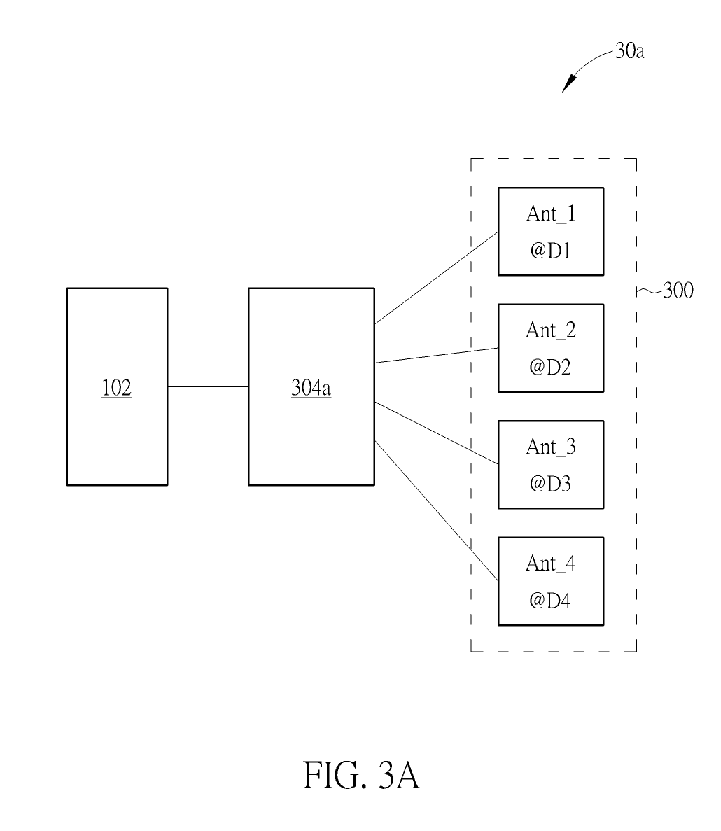

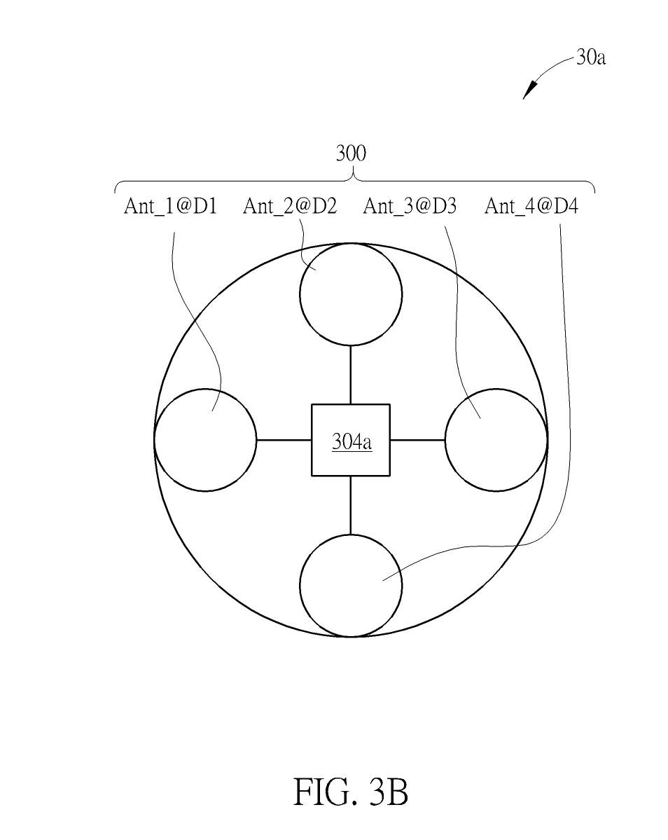

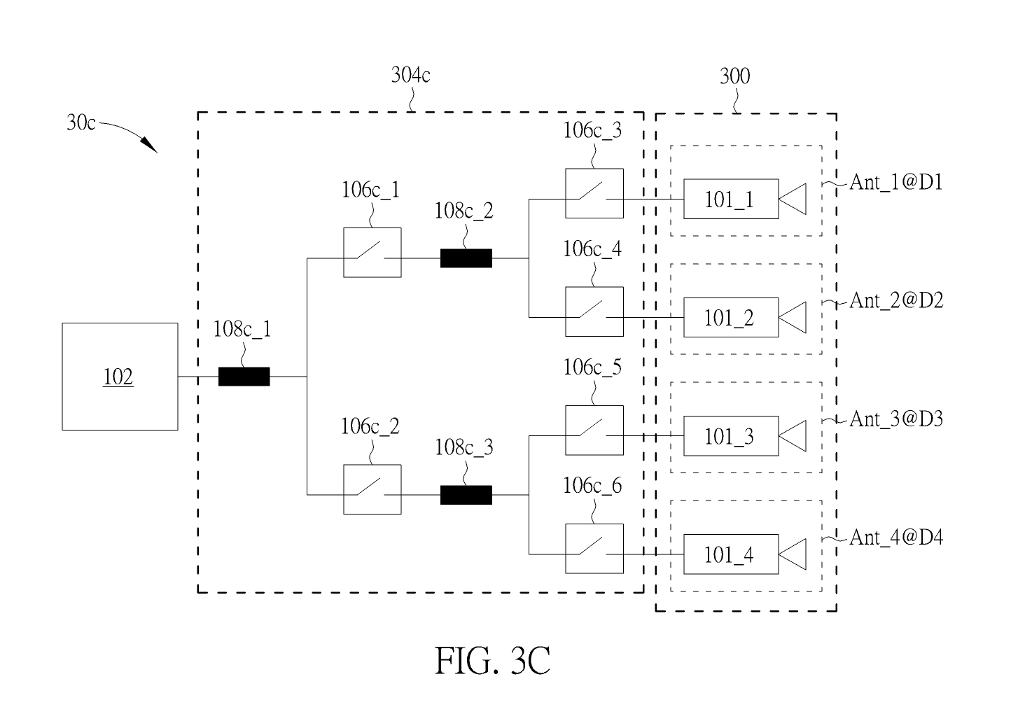

Besides, in the radio-frequency transceiver system 10, n means how many the antenna units Ant_1-Ant_n and the directions D1-Dn respectively there are, and can be adjusted according to different system requirements. For example, please refer to FIGS. 3A and 3B. FIG. 3A is a schematic diagram illustrating a radio-frequency transceiver system 30a according to an embodiment of the present invention. FIG. 3B is a top-view schematic diagram illustrating the radio-frequency transceiver system 30a. As shown in FIGS. 3A and 3B, the antenna units Ant_1-Ant_4 of the radio-frequency transceiver system 30a are disposed (interspersed) regularly and alternately toward the directions D1-D4 in an antenna set 300, such that the radio-frequency transceiver system 30a can transmit or receive radio-frequency signals omni-directionally.

Moreover, FIG. 3C is a schematic diagram illustrating a radio-frequency transceiver system 30c according to an embodiment of the present invention. Since the structure of the radio-frequency transceiver system 30c is similar to that of the radio-frequency transceiver system 30a in FIG. 3A, the same numerals and symbols denote the same components in the following description, and the identical parts are not detailed redundantly. As shown in FIG. 3C, a switching module 304c of the radio-frequency transceiver system 30c is a multistage switch circuit. Because lengths of transmission lines 108c_1-108c_3 are substantially one quarter of a wavelength associated with the operating frequency, resistances of the transmission lines 108c_1-108c_3 are respectively 50 ohm. Accordingly, when the radio-frequency transceiver system 30c is operated in the omnidirectional mode, switches 106c_1-106c_6 are turned on to conduct electric currents, such that radio-frequency signals can be transmitted between the antenna unit 106c_1-106c_6 and the radio-frequency signal processing module 102. Because resistances of the feed-in wires 101_1-101_4 of the antenna units Ant_1-Ant_4 are respectively 50 ohm, impedance matching can be achieved between the feed-in wires 101_1, 101_2 connected in parallel and the transmission line 108c_2 of 50 ohm, between the feed-in wires 101_3, 101_4 connected in parallel and the transmission line 108c_3 of 50 ohm, and between the feed-in wires 108c_2, 108c_3 connected in parallel and the transmission line 108c_1 of 50 ohm. In other words, the feed-in wires 101_1, 101_2 connected in parallel and the transmission line 108c_2 perform impedance matching; the feed-in wires 101_3, 101_4 connected in parallel and the transmission line 108c_3 perform impedance matching; the feed-in wires 108c_2, 108c_3 connected in parallel and the transmission line 108c_1 perform impedance matching. When the radio-frequency transceiver system 30c is operated in the directional mode, only a portion of the switches (for example, the switch 106c_1) is turned on. Therefore, radio-frequency signals are transmitted only between a specific antenna unit (for example, the antenna unit Ant_1) and the radio-frequency signal processing module 102, and are transmitted or received along a specific direction (for example, the direction D1). In such a situation, since resistances of the feed-in wires (for example, the feed-in wire 101_1) are 50 ohm, impedance matching can be achieved between one of the feed-in wires and one of the transmission lines of 50 ohm (for example, the transmission line 108c_2). Similarly, the transmission line 108c_2 and the transmission line 108c_1 of 50 ohm perform impedance matching.

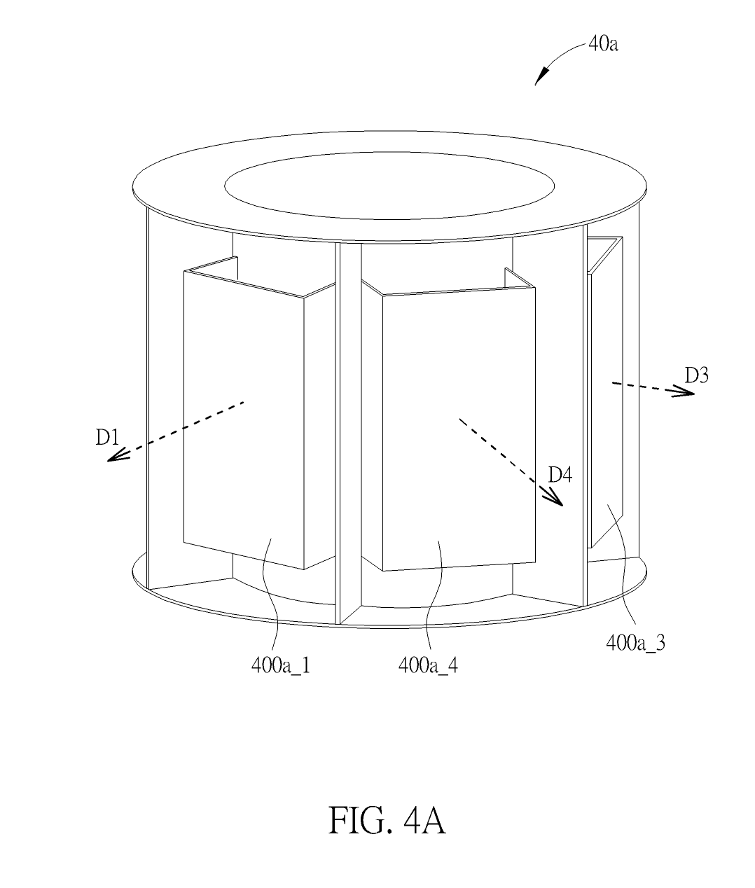

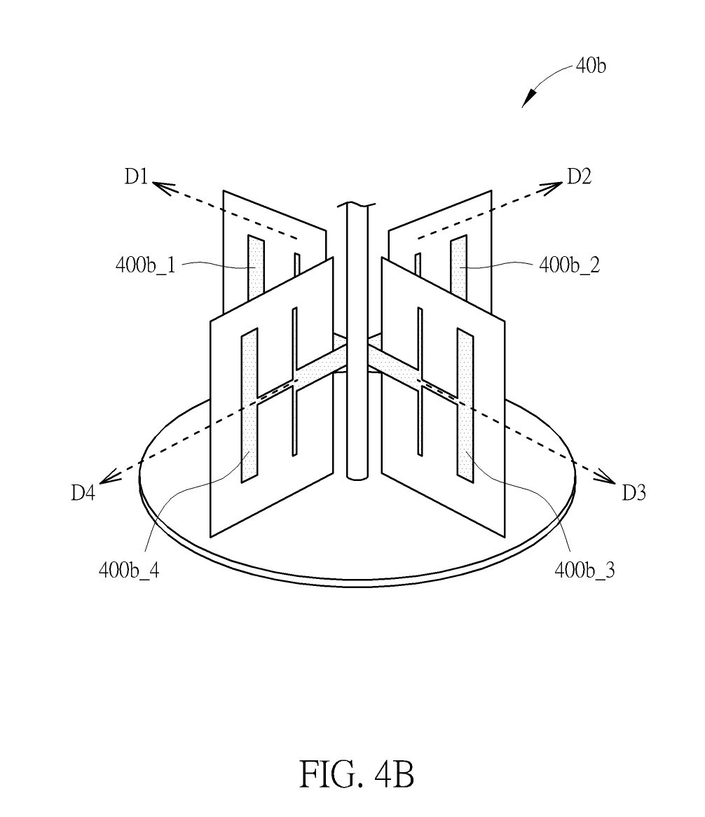

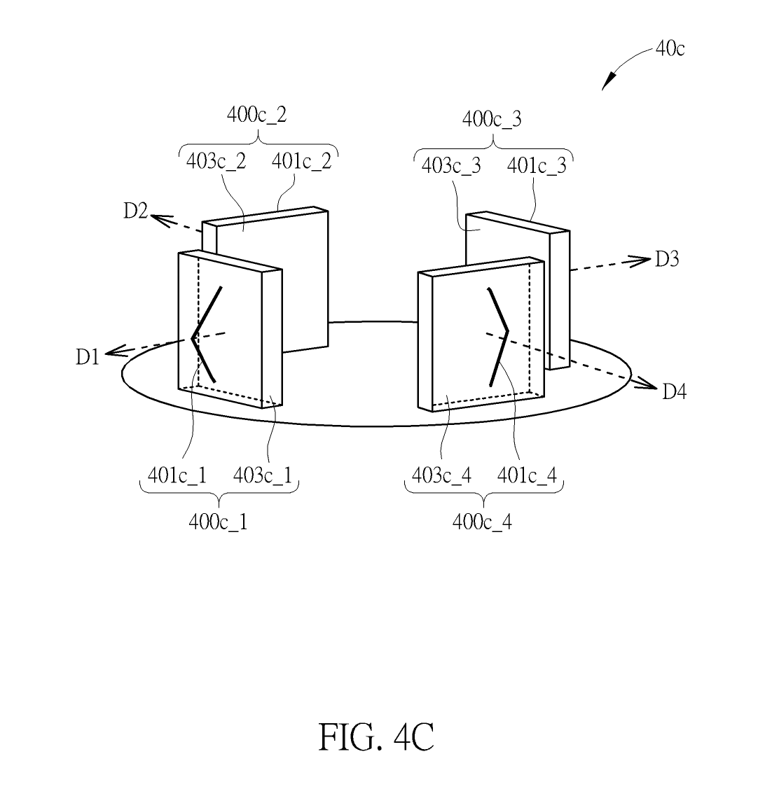

As set forth above, the implementation of the switching module or number of the antenna units may be adjusted according to system requirements. However, types of the antenna units may vary. For example, the antenna units may be for example a patch antenna, a Yagi-type antenna, a dipole antenna, a cross dipole antenna, a horn antenna, a wire inverted F-shaped antenna (WIFA) and a planar inverted F-shaped antenna (PIFA). Specifically, please refer to FIGS. 4A, 4B and 4C. FIG. 4A is a schematic diagram illustrating a radio-frequency transceiver system 40a according to an embodiment of the present invention. FIG. 4B is a schematic diagram illustrating a radio-frequency transceiver system 40b according to an embodiment of the present invention. FIG. 4C is a schematic diagram illustrating a radio-frequency transceiver system 40c according to an embodiment of the present invention. As shown in FIG. 4A, the antenna units 400a—1-400a—4 of the radio-frequency transceiver system 40a are respectively disposed toward the directions D1-D4, and are respectively a patch antenna. The directions D1-D4 are respectively defined as directions from ground terminals (i.e., ground planes) of the antenna units 400a_1-400a_4 to the corresponding radiation terminals (e.g., radiators). As shown in FIG. 4B, the antenna units 400b_1-400b_4 of the radio-frequency transceiver system 40b are respectively disposed toward the directions D1-D4, and are respectively a Yagi-type antenna. The directions D1-D4 are respectively defined as directions from reflection terminals of the antenna units 400b_1-400b_4 to the corresponding radiation terminals. As shown in FIG. 4C, the antenna units 400c_1-400c_4 of the radio-frequency transceiver system 40c are respectively disposed toward the directions D1-D4, and respectively comprise dipole antennas 401c_1-401c_4 and cavity-backed structures 403c_1-403c_4. The directions D1-D4 are respectively defined as directions from the cavity-backed structures 403c_1-403c_4 to the dipole antennas 401c_1-401c_4. Because the antenna units 400a_1-400a_4, 400b_1-400b_4 and 400c_1-400c_4 of the radio-frequency transceiver systems 40a-40c are appropriately arranged, the radio-frequency transceiver system 40a-40c are able to transmit or receive radio-frequency signals omni-directionally, and coverage is enhanced.

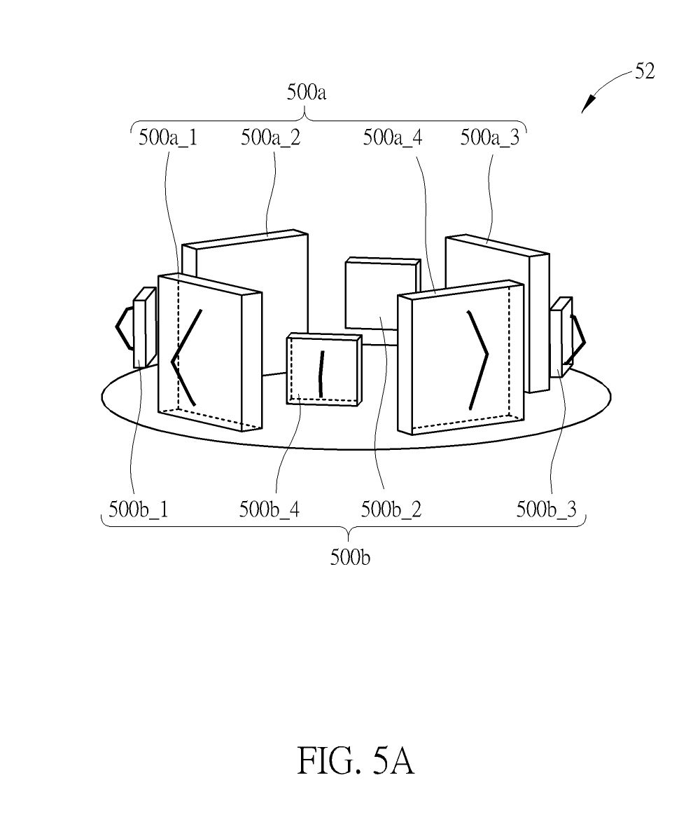

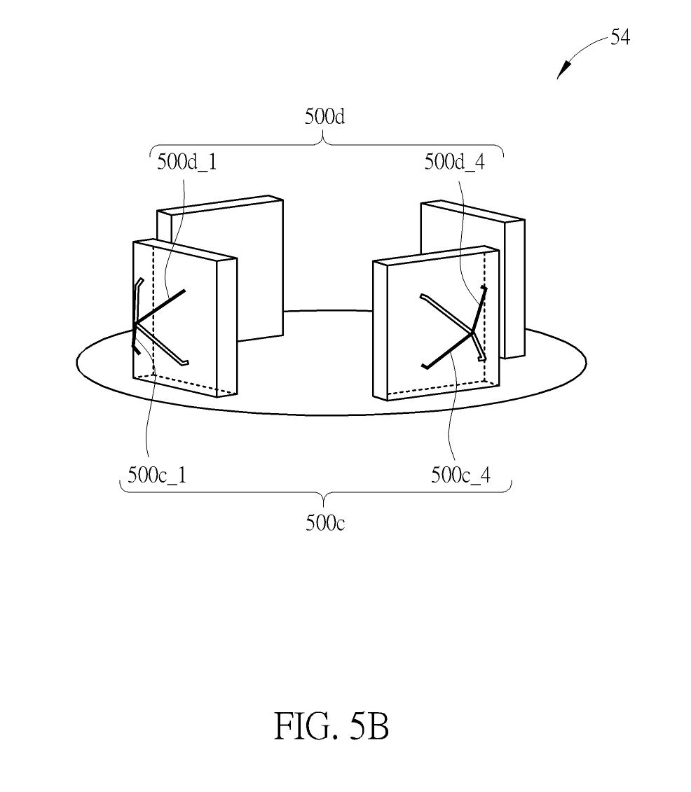

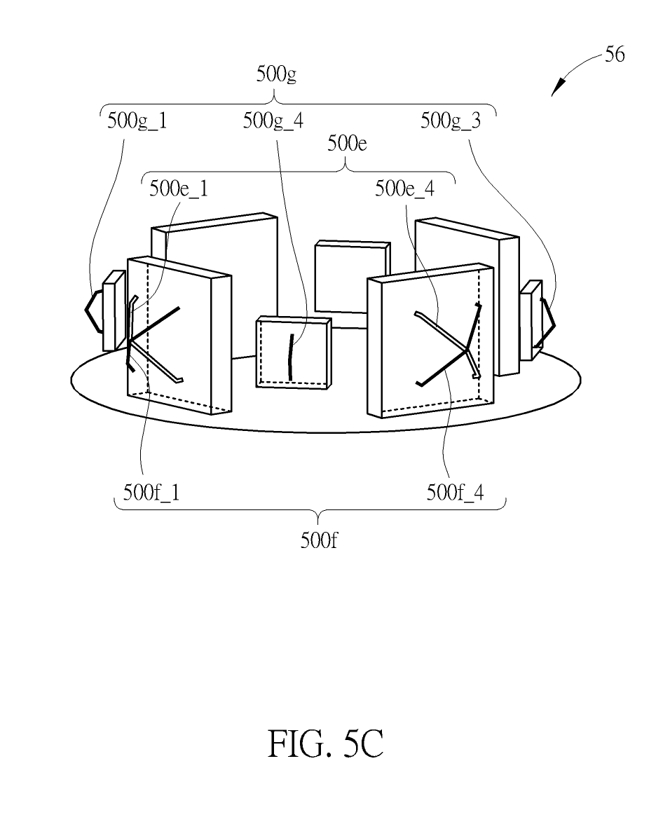

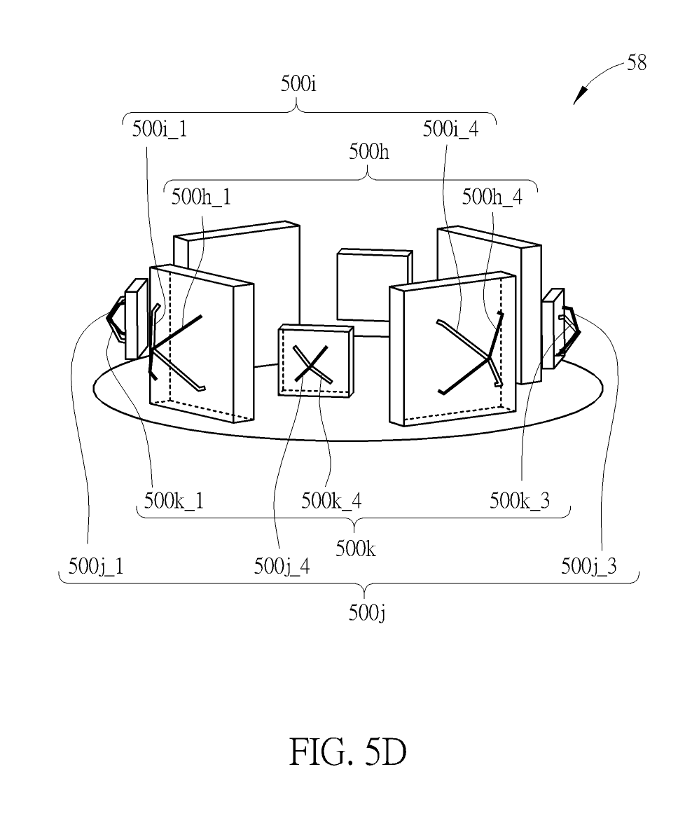

The radio-frequency transceiver system of the present invention may comprise a plurality of antenna sets and provide a plurality of data streams to be accommodated for multiple-input multiple-output (MIMO) system. Please refer to FIGS. 5A, 5B, 5C and 5D. FIG. 5A is a schematic diagram illustrating a radio-frequency transceiver system 52 according to an embodiment of the present invention. FIG. 5B is a schematic diagram illustrating a radio-frequency transceiver system 54 according to an embodiment of the present invention. FIG. 5C is a schematic diagram illustrating a radio-frequency transceiver system 56 according to an embodiment of the present invention. FIG. 5D is a schematic diagram illustrating a radio-frequency transceiver system 58 according to an embodiment of the present invention. As shown in FIG. 5A, the radio-frequency transceiver system 52 comprises antenna sets 500a and 500b. Antenna units 500a_1-500a_4 of the antenna set 500a and antenna units 500b_1-500b_4 of the antenna set 500b are regularly and alternately arranged in the radio-frequency transceiver system 52. The antenna sets 500a and 500b are respectively controlled by a switching module (not shown in FIG. 5A) to switch the radio-frequency transceiver system 52 between the omnidirectional mode and the directional mode. The antenna units 500a_1-500a_4 and the antenna units 500b_1-500b_4 may be a dipole antenna respectively, but the present invention is not limited herein and each two dipole antenna may be grouped together into a cross dipole antenna to form the radio-frequency transceiver system 54 as shown in FIG. 5B. With antenna units 500c_1-500c_4 of an antenna set 500c and antenna units 500d_1-500d_4 of an antenna set 500d, a plurality of data streams can be transmitted and/or received. Similarly, the antenna set 500c and the antenna set 500d may be controlled by a switching module (not shown in FIG. 5B) respectively to switch the radio-frequency transceiver system 54 between the omnidirectional mode or the directional mode.

Additionally, as shown in FIG. 5C, the radio-frequency transceiver system 56 comprises antenna sets 500e, 500f and 500g. Antenna units 500e_1-500e_4 of the antenna set 500e, antenna units 500f_1-500f_4 of the antenna set 500f and antenna units 500g_1-500g_4 of the antenna set 500g are respectively a dipole antenna, while dipole antennas of the antenna units 500e_1-500e_4 and dipole antennas of the corresponding antenna units 500f_1-500f_4 are grouped together to constitute a cross dipole antenna respectively. The antenna sets 500e, 500f and 500g are regularly and alternately arranged in the radio-frequency transceiver system 56, and the antenna sets 500e, 500f and 500g are controlled by a switching module (not shown in FIG. 5C) respectively to switch the radio-frequency transceiver system 56 between the omnidirectional mode or the directional mode. As shown in FIG. 5D, the radio-frequency transceiver system 58 comprises antenna sets 500h, 500i, 500j and 500k. Antenna units 500h_1-500h_4 of the antenna set 500h, antenna units 500i_1-500i_4 of the antenna set 500i, Antenna units 500j_1-500j_4 of the antenna set 500j and antenna units 500k_1-500k_4 of the antenna set 500k are respectively a dipole antenna. Dipole antennas of the antenna units 500h_1-500h_4 and dipole antennas of the corresponding antenna units 500i_1-500i_4 are grouped together into a cross dipole antenna respectively, and dipole antennas of the antenna units 500j_1-500j and dipole antennas of the corresponding antenna units 500k_1-500k_4 are grouped together into a cross dipole antenna respectively. The antenna sets 500h, 500i, 500j and 500k are regularly and alternately arranged in the radio-frequency transceiver system 58, and the antenna sets 500h, 500i, 500j and 500k are controlled by a switching module (not shown in FIG. 5D) respectively to switch the radio-frequency transceiver system 58 between the omnidirectional mode or the directional mode. In other words, since the radio-frequency transceiver systems 52, 54, 56, 58 can transmit and receive a plurality of data streams, system throughput can be increased. Furthermore, the antenna sets 500a-500k in the aforementioned embodiments are respectively a dipole antenna; nevertheless, the present invention is not limited to this and antenna sets may be other types of antennas and provide a plurality of data streams according to other system requirements.

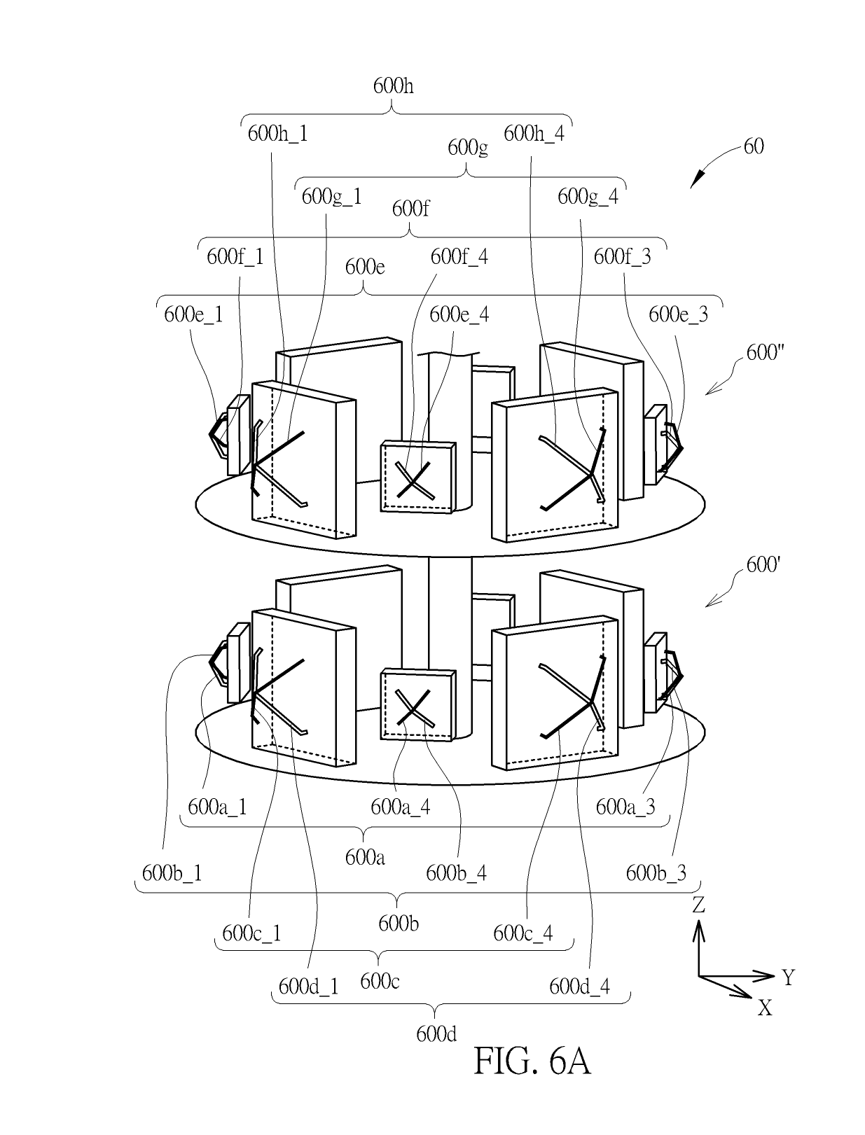

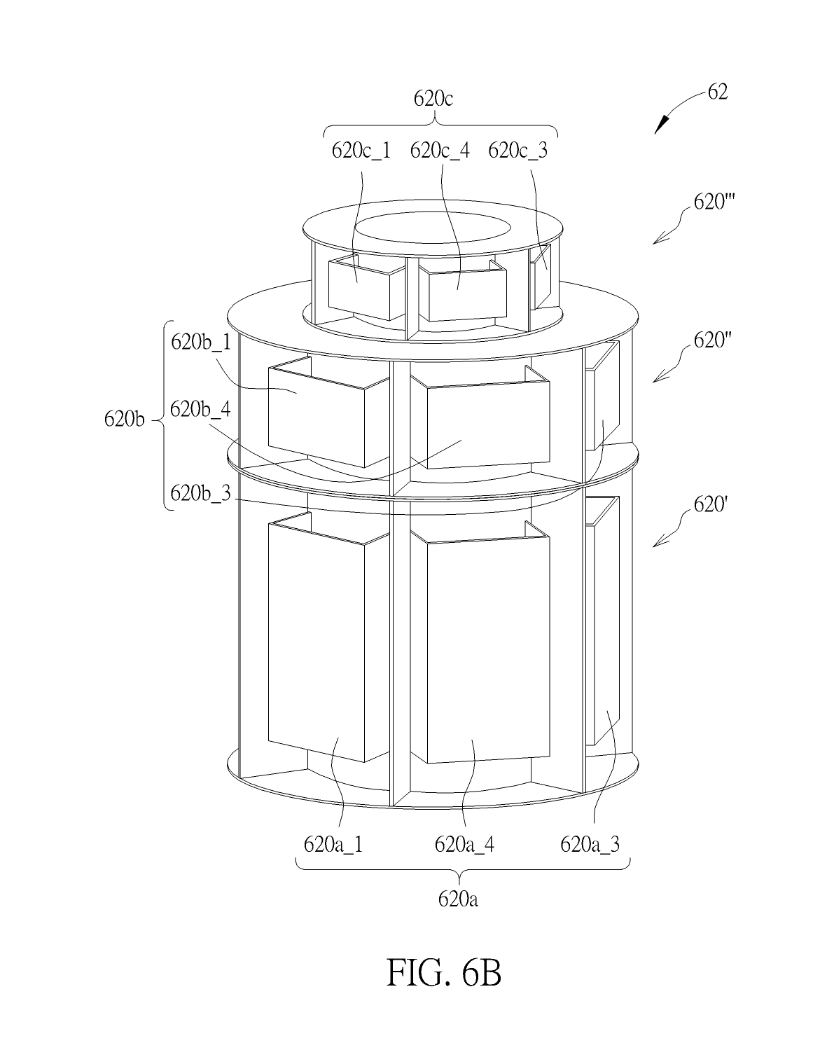

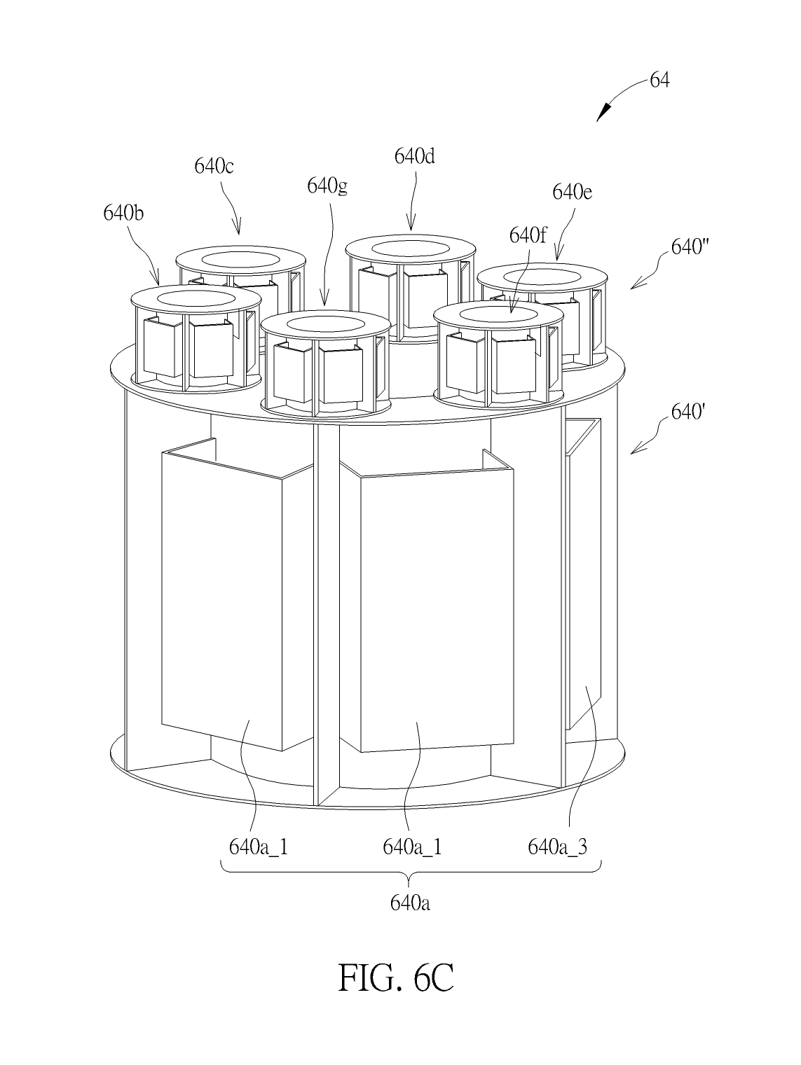

The antenna sets in the embodiments mentioned above are regularly and alternately interlaced in the radio-frequency transceiver systems respectively to provide a plurality of data streams; in addition, antenna sets may be stacked to form a composite (synthesized) antenna radiation pattern. Specifically, please refer to FIGS. 6A, 6B and 6C. FIG. 6A is a schematic diagram illustrating a radio-frequency transceiver system 60 according to an embodiment of the present invention. FIG. 6B is a schematic diagram illustrating a radio-frequency transceiver system 62 according to an embodiment of the present invention. FIG. 6C is a schematic diagram illustrating a radio-frequency transceiver system 64 according to an embodiment of the present invention. As shown in FIG. 6A, the radio-frequency transceiver system 60 comprises antenna sets 600a-600h. The antenna sets 600a-600d constitutes an antenna structure stratum 600′, and the antenna sets 600e-600h constitutes an antenna structure stratum 600″. The antenna structure stratum 600′ is stacked on the antenna structure stratum 600″, and the antenna sets 600a600d and the antenna sets 600e-600h are regularly and alternately arranged in the antenna structure stratum 600′ and the antenna structure stratum 600″ respectively, thereby expanding coverage and increasing system throughput. Additionally, as shown in FIG. 6B, the radio-frequency transceiver system 62 may comprise a plurality of antenna sets 620a-620c constituting antenna structure strata 620′, 620″, 620′″ according different system requirements. The way to stack the antenna sets may be modified as well. For example, antenna sets 640b-640g of the radio-frequency transceiver system 64 may constitute an antenna structure stratum 640″ as shown in FIG. 6C, and stack on the antenna structure stratum 640′ formed from an antenna set 640a.

Please note that the antenna sets of the radio-frequency transceiver system in the above-mentioned embodiments can respectively transmit or receive radio-frequency signals of different frequency bands. For example, the antenna sets 600a, 600b, 600e and 600f of the radio-frequency transceiver system 60 as shown in FIG. 6A can transmit or receive radio-frequency signals in the frequency band for 5 GHz (i.e., the frequency band around 5 GHz), the antenna sets 600c, 600d, 600g and 600h can transmit or receive radio-frequency signals in the frequency band for 2.4 GHz. As the total number of antenna sets increases, a radio-frequency transceiver system can transmit or receive radio-frequency signals with wider frequency range; consequently, if the transmission standard changes, the radio-frequency transceiver system still meets requirements for 2.4 GHz, 5 GHz or other frequency bands. For example, the radio-frequency transceiver system 62 as shown in FIG. 6B can transmit or receive radio-frequency signals in the frequency bands for 2.4 GHz, 5 GHz, 60 GHz and so on with the antenna structure strata 620′, 620″ and 620′″; the radio-frequency transceiver system 64 as shown in FIG. 6C can transmit or receive radio-frequency signals in the frequency bands for 2.4 GHz, 60 GHz and so on with the antenna structure strata 640′ and 640″.

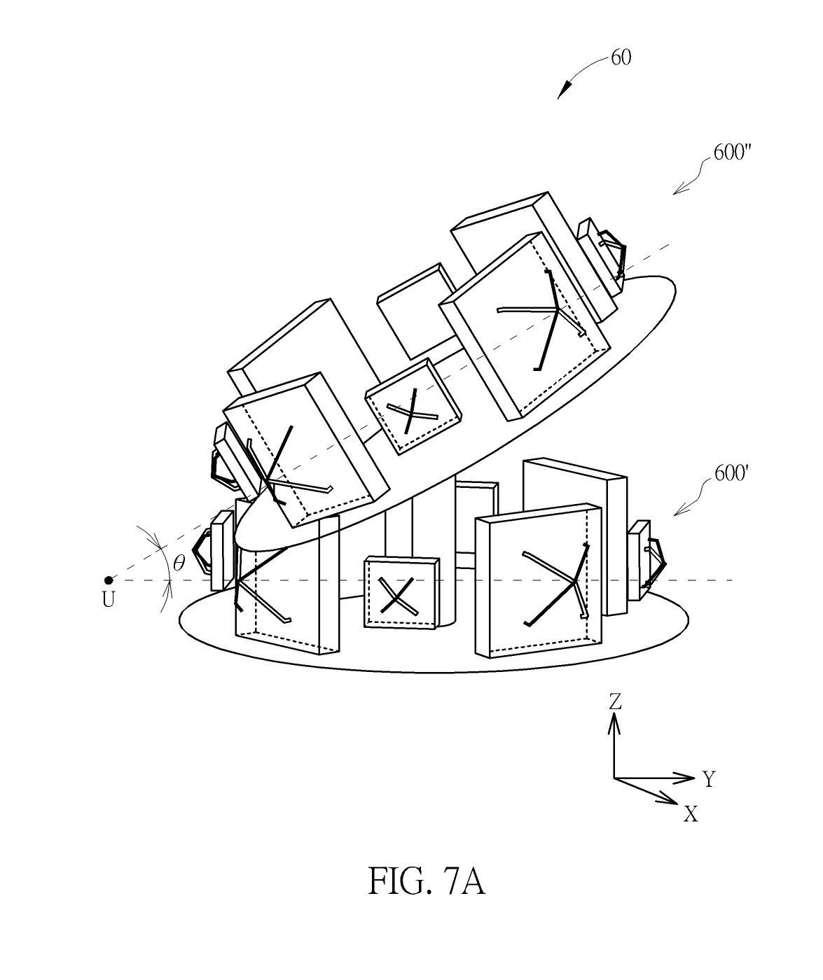

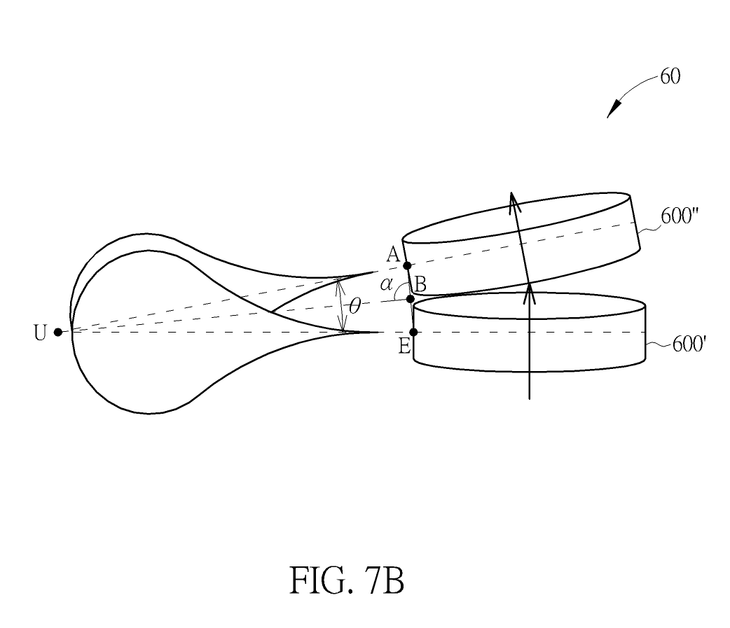

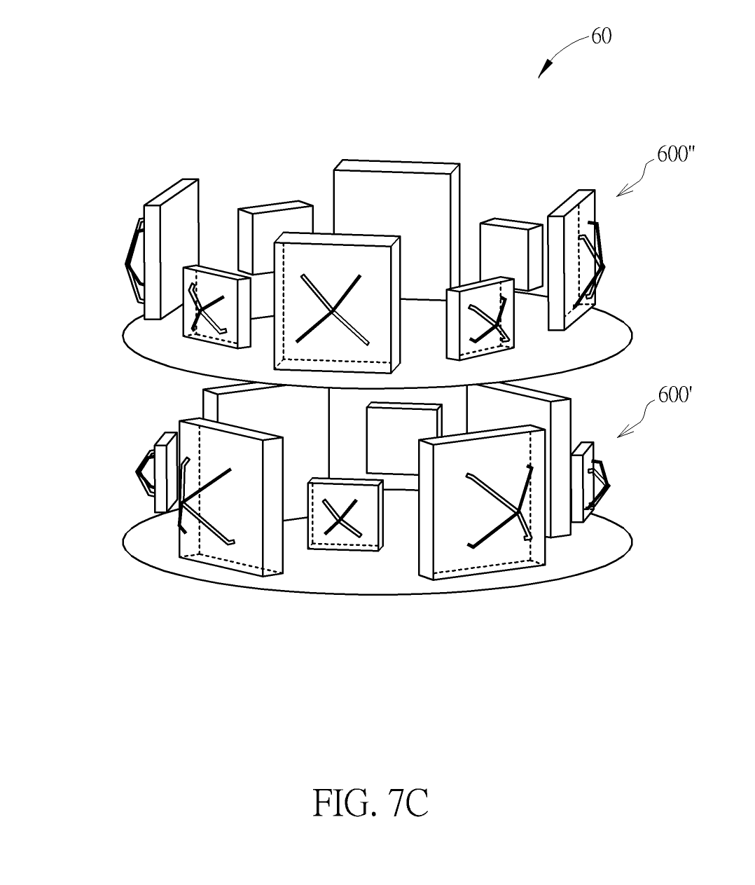

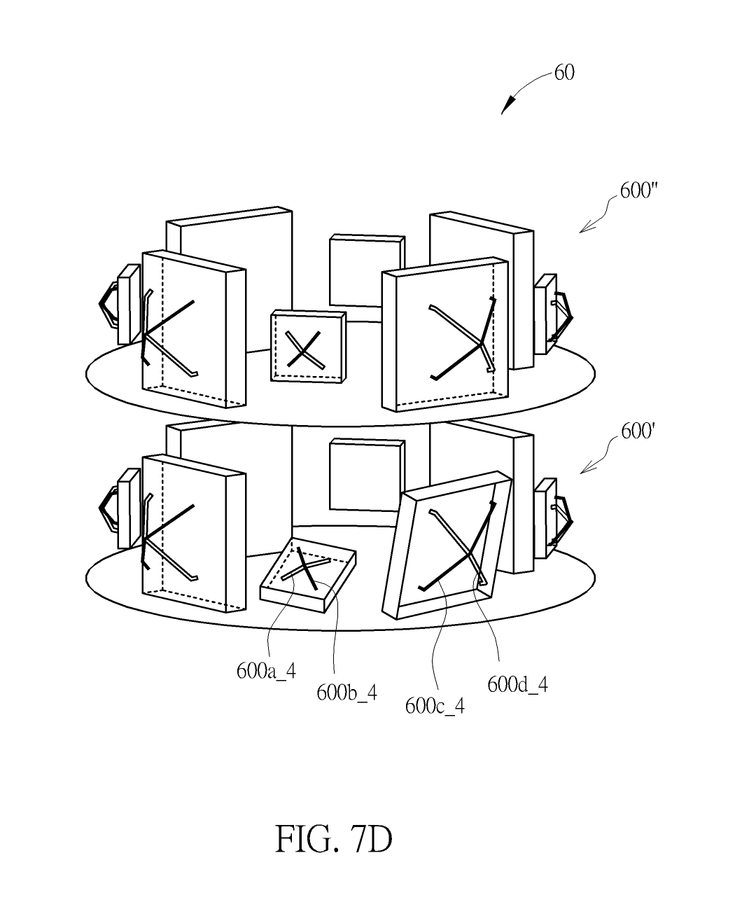

To focus beam pattern onto a particular point or position, an included angle between different antenna structure strata—i.e., an angle enclosed by two adjacent antenna structure strata—can be properly adjusted. For example, please refer to FIGS. 7A and 7B. FIG. 7A is a schematic diagram illustrating the tilted antenna structure strata 600′ and 600″ of the radio-frequency transceiver system 60 shown in FIG. 6A. FIG. 7B is a schematic diagram illustrating an included angle θ between the antenna structure strata 600′ and 600″. As shown in FIG. 7A, extension of the antenna structure stratum 600′ toward a source of radio-frequency signals and extension of the antenna structure stratum 600″ toward the source enclose the included angle θ as shown in FIG. 7B; consequently, beam pattern can be focused onto a particular point or position to optimize system efficiency. The magnitude of the included angle θ can be determined by using various different approaches. For example, since the direction of arrival (DOA) is useful to estimate the direction of an incoming radio-frequency signal in space according to the space-time relationship of the radio-frequency signal, the magnitude of the included angle θ can be found. Specifically, a reference signal s₀ at different sample time and sample signals S₁-s_{N} must be measured first. Then, the sample signals s₁-s_{N} constitute a signal matrix s and a covariance matrix C. The signal matrix s and the reference signal s₀ constitute a cross correlation vector d. Moreover, a weighting vector w can be derived from the inverse of the covariance matrix C and the cross correlation vector d. Consequently, the direction of arrival is given with the normalized x, y coordinates (xₙ,yₙ) of the n-th antenna unit, a composite radiation pattern E_{c}(φ,θ), a reference radiation pattern E₀(φ,θ), an embedded radiation pattern Eₙ(φ,θ), and a normalized composite power distribution P(φ,θ). The exact relation is defined as follows:

$$C = {S}^{* {T}_{S}}$$

$$d = {S}^{* {T}_{{S}_{0}}}$$

$$w = - {C}^{- 1} d$$

$${E}_{C} ( ϕ , θ ) = {E}_{0} ( ϕ , θ ) + {\sum }_{n = 1}^{N} {w}_{n} {E}_{n} ( ϕ , θ ) {e}^{- i π sin θ ( {x}_{n} cos ϕ + {y}_{n} sin ϕ )}$$

$$P ( ϕ , θ ) = \frac{{\vert {E}_{0} ( ϕ , θ ) \vert}^{2}}{{\vert {E}_{C} ( w , ϕ , θ ) \vert}^{2}}$$

On the other hand, Angle of Arrival (AOA) is also feasible to estimate the direction of an incoming radio-frequency signal in space by means of the measured phase difference between the antenna structure strata 600′ and 600″, thereby determining the magnitude of the included angle θ. Specifically, the antenna structure strata 600′ and 600″ are respectively located at points A and E, and a point B is the midpoint between the points A and E. The source of radio-frequency signals is located at a point U, and a phase difference between a phase, which is between the antenna structure stratum 600′ and the source of radio-frequency signals, and another phase, which is between the antenna structure stratum 600″ and the source, is Dₚₕₐₛₑ. If both the distance d_{UA} between the antenna structure stratum 600′ and the source and the distance d_{UE} the between the antenna structure stratum 600″ and the source are much greater than the distance d_{AE} between the antenna structure strata 600′, 600″, the included angle α (and the included angle θ accordingly) can be computed as follows:

$${d}_{UA}^{2} = {d}_{UB}^{2} + {d}_{AB}^{2} - 2 {d}_{UB} * {d}_{AB} * cos α$$

$${d}_{UE}^{2} = {d}_{UB}^{2} + {d}_{BE}^{2} + 2 {d}_{UB} * {d}_{BE} * cos α$$

$$cos α = \frac{{d}_{phase}}{- 2 d}$$

Practically, the included angle θ can be adjusted by means of a mechanical device such as a step motor.

Besides, different antenna structure strata maybe misaligned with respect to a centerline. For example, please refer to FIG. 7C. FIG. 7C is a schematic diagram illustrating misalignments of a portion of the antenna sets 600a-600g of the radio-frequency transceiver system 60 shown in FIG. 6A. As shown in FIG. 7C, the antenna sets 600a-600d of the antenna structure stratum 600′ and the antenna sets 600e-600h of the antenna structure stratum 600″ misalign to adjust radiation pattern, and it appears that the antenna structure stratum 600′ is rotated with respect to the shared centerline of the antenna structure stratum 600″ and the antenna structure stratum 600′. What's more, angle of each antenna set of an antenna structure stratum with respect to the plane of the antenna structure stratum may be adjusted according to different requirements. For example, please refer to FIG. 7D. FIG. 7D is a schematic diagram illustrating the antenna sets 600a-600g of the radio-frequency transceiver system 60 shown in FIG. 6A. As shown in FIG. 7D, cross dipole antennas formed from the antenna units 600a_4, 600b_4, 600c_4 and 600d_4 of the antenna sets 600a-600g rotate with respect to the other antenna units. Besides, the distance between two adjacent antenna structure strata—that is, the height of each antenna structure stratum—may be adjusted according to different system requirements to optimize system efficiency.

To sum up, with the switching circuits of the switching module, the radio-frequency transceiver system can switch between the omnidirectional mode and the directional mode to transmit or receive radio-frequency signals either omni-directionally or along a specific direction. Because the radio-frequency transceiver system comprises a plurality of antenna sets and provide a plurality of data streams, multiple-input multiple-output (MIMO) technique can be applied. When the antenna sets are properly stacked, a composite antenna radiation pattern is formed to expand coverage and increase system throughput. Moreover, by properly adjusting the included angle between the antenna sets, optimized system efficiency can be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio-frequency transceiver system, adapted to a wireless local area network, the radio-frequency transceiver system comprising:
an antenna set, comprising a plurality of antenna units, wherein
the plurality of antenna units are respectively disposed toward a plurality of directions;
a radio-frequency signal processing module, configured to process radio-frequency signals; and
a switching module, electrically coupled between the antenna set and the radio-frequency signal processing module to switch the radio-frequency signal processing module between the plurality of antenna units of the antenna set, and to switch the radio-frequency transceiver system between an omnidirectional mode and a directional mode;
wherein electric currents are conducted between the radio-frequency signal processing module and the plurality of antenna units operated in the omnidirectional mode to transmit or receive radio-frequency signals omni-directionally, and electric currents are conducted between the radio-frequency signal processing module and one of the plurality of antenna units operated in the directional mode to transmit or receive radio-frequency signals along a first direction of the plurality of directions.

2. The radio-frequency transceiver system of claim 1, wherein each of the plurality of antenna units is selected from a dipole antenna, a cross dipole antenna, a patch antenna, a planar inverted F-shaped antenna (PIFA), a wire inverted F-shaped antenna (WIFA), a horn antenna and a Yagi-type antenna.

3. The radio-frequency transceiver system of claim 1, wherein the plurality of antenna units are respectively a first antenna unit, a second antenna unit, a third antenna unit and a fourth antenna unit, the switching module comprises a multistage switch circuit corresponding to the antenna set, and the multistage switch circuit comprises:
a first switch, electrically coupled to a first feed-in wire of the first antenna unit;
a second switch, electrically coupled to a second feed-in wire of the second antenna unit;
a third switch, electrically coupled to a third feed-in wire of the third antenna unit;
a fourth switch, electrically coupled to a fourth feed-in wire of the fourth antenna unit;
a first transmission line, electrically coupled to the first switch and the second switch;
a second transmission line, electrically coupled to the third switch and the fourth switch;
a fifth switch, electrically coupled to the first transmission line;
a sixth switch, electrically coupled to the second transmission line; and
a third transmission line, wherein a terminal of the third transmission line is electrically coupled to the fifth switch and the sixth switch, and another terminal of the third transmission line is electrically coupled to the radio-frequency signal processing module.

4. The radio-frequency transceiver system of claim 1, wherein the first switch, the second switch, the third switch, the fourth switch, the fifth switch and the sixth switch are respectively selected from a diode, a micro-electromechanical systems (MEMS) switch and a solid state switch.

5. The radio-frequency transceiver system of claim 1, wherein resistances of the first transmission line, the second transmission line and the third transmission line are 50 ohm respectively.

6. A radio-frequency transceiver system, adapted to a wireless local area network, the radio-frequency transceiver system comprising:
a plurality of antenna sets, wherein each of the plurality of antenna sets comprises a plurality of antenna units, and the plurality of antenna units are respectively disposed toward a plurality of directions;
a radio-frequency signal processing module, configured to process radio-frequency signals; and
a switching module, electrically coupled between the plurality of the antenna sets and the radio-frequency signal processing module to switch the radio-frequency signal processing module between the plurality of antenna units of the plurality of antenna sets, and to switch the radio-frequency transceiver system between an omnidirectional mode and a directional mode;
wherein electric currents are conducted between the radio-frequency signal processing module and the plurality of antenna units of at least one antenna set of the plurality of antenna sets operated in the omnidirectional mode to transmit or receive radio-frequency signals omni-directionally, and electric currents are conducted between the radio-frequency signal processing module and one of the plurality of antenna units of at least one antenna set of the plurality of antenna sets operated in the directional mode to transmit or receive radio-frequency signals along a first direction of the plurality of directions.

7. The radio-frequency transceiver system of claim 6, wherein each of a first antenna set and a second antenna set of the plurality of antenna sets are able to provide a plurality of data streams.

8. The radio-frequency transceiver system of claim 7, wherein each of the plurality of antenna units of the first antenna set is respectively a first dipole antenna, and each of the plurality of antenna units of the second antenna set is respectively a second dipole antenna and constitutes a cross dipole antenna together with the first dipole antenna corresponding to the second antenna set.

9. The radio-frequency transceiver system of claim 6, wherein the plurality of antenna sets cover a plurality of frequency bands.

10. The radio-frequency transceiver system of claim 6, wherein a first antenna set of the plurality of antenna set is stacked on a second antenna set of the plurality of antenna set.

11. The radio-frequency transceiver system of claim 10, wherein the second antenna set is tilted with respect to the first antenna set.

12. The radio-frequency transceiver system of claim 10, wherein the second antenna set is rotated with respect to the first antenna set.

13. The radio-frequency transceiver system of claim 6, wherein each of the plurality of antenna units is selected from a dipole antenna, a cross dipole antenna, a patch antenna, a planar inverted F-shaped antenna (PIFA), a wire inverted F-shaped antenna (WIFA), a horn antenna and a Yagi-type antenna.

14. The radio-frequency transceiver system of claim 6, wherein the plurality of antenna units are respectively a first antenna unit, a second antenna unit, a third antenna unit and a fourth antenna unit, the switching module comprises a plurality of multistage switch circuits corresponding to the plurality of antenna sets, and each of the plurality of multistage switch circuits comprises:
a first switch, electrically coupled to a first feed-in wire of the first antenna unit;
a second switch, electrically coupled to a second feed-in wire of the second antenna unit;
a third switch, electrically coupled to a third feed-in wire of the third antenna unit;
a fourth switch, electrically coupled to a fourth feed-in wire of the fourth antenna unit;
a first transmission line, electrically coupled to the first switch and the second switch;
a second transmission line, electrically coupled to the third switch and the fourth switch;
a fifth switch, electrically coupled to the first transmission line;
a sixth switch, electrically coupled to the second transmission line; and
a third transmission line, wherein a terminal of the third transmission line is electrically coupled to the fifth switch and the sixth switch, and another terminal of the third transmission line is electrically coupled to the radio-frequency signal processing module.

15. The radio-frequency transceiver system of claim 6, wherein the first switch, the second switch, the third switch, the fourth switch, the fifth switch and the sixth switch are respectively selected from a diode, a micro-electromechanical systems (MEMS) switch and a solid state switch.

16. The radio-frequency transceiver system of claim 6, wherein resistances of the first transmission line, the second transmission line and the third transmission line are 50 ohm respectively.
